(19) United States
(12) Patent Application Publication
(10) Pub. No.: US 2016/0248747 A1
(43) Pub. Date: Aug. 25, 2016

(54) METHOD, TERMINAL AND SYSTEM FOR ASSOCIATING USER RESOURCE INFORMATION

(71) Applicant: TENCENT TECHNOLOGY (SHENZHEN) COMPANY LIMITED, Shenzhen (CN)

(72) Inventors: Wa YE, Shenzhen (CN); Wei MAO, Shenzhen (CN); Qiang LU, Shenzhen (CN); Deyuan LI, Shenzhen (CN); Zhenyu XU, Shenzhen (CN)

(21) Appl. No.: 15/141,614

(22) Filed: Apr. 28, 2016

Related U.S. Application Data
(63) Continuation of application No. PCT/CN2014/095965, filed on Dec. 31, 2014.

(30) Foreign Application Priority Data
Jan. 3, 2014 (CN) 201410003617.9

(51) Int. Cl. H04L 29/06; G06K 7/14; G06K 7/10

(52) U.S. Cl. CPC H04L 63/08; H04L 63/10; H04L 63/126; G06K 7/1095; G06K 7/1417

(57) ABSTRACT

A method for associating user resource information includes: acquiring user resource information, associated with a first user identifier of a user, in a first network platform, where the first user identifier is used for identifying the user in the first network platform and the user resource information is used for performing value transfer during data processing; and sending a second user identifier of the user and the user resource information to a second network platform, where the second user identifier is used for identifying the user in the second network platform and the first user identifier and the second user identifier are both user identifiers registered by the user separately in the first network platform and the second network platform, so that the second network platform associates the second user identifier with the user resource information.

### PRIORITY CLAIM AND RELATED APPLICATION

This application is a continuation of International Application No. PCT/CN2014/095965, filed on Dec. 31, 2014, which claims priority to Chinese Patent Application No. 201410003617.9, entitled “METHOD, TERMINAL AND SYSTEM FOR ASSOCIATING USER RESOURCE INFORMATION” filed on Jan. 3, 2014, both of which are hereby incorporated by reference in their entireties.

### BACKGROUND

1. Field

The present disclosure relates to the field of Internet communications, and in particular, to a method, terminal and system for associating user resource information.

2. Description of the Related Art

At present, a user logs in to a network platform by using a user identifier and performs value transfer processing by using the network platform. In addition, at the beginning of the processing, the network platform needs to acquire user resource information associated with the user identifier and perform the value transfer processing according to the user resource information.

Before the processing starts, the network platform needs to associate the user identifier of the user with the user resource information. A specific association process is as follows: a network platform first displays an information input interface on a terminal, where a user may input user resource information, of the user, used for value transfer, to the information input interface. Then, the terminal sends a user identifier of the user and the user resource information to the network platform and the network platform further associates the user identifier with the user resource information.

Because user resource information includes multiple pieces of information such as a card number, a name, an identity card number and a mobile number, of a user, if the user manually inputs each piece of information to a terminal, it causes a long input time and low efficiency of associating the user resource information; and if the terminal used by the user is a mobile phone, it is easy for the user to input wrong user resource information due to a small keypad of the mobile phone, which causes an association failure and needs the user to perform re-association, thereby further reducing the efficiency of associating the user resource information.

### SUMMARY

In light of the issues associated with the conventional method, embodiments of the present disclosure provide a method, terminal and system for associating user resource information. The technical solution is as follows:

According to an aspect, a method for associating user resource information is provided, where the method includes:
acquiring user resource information, associated with a first user identifier of a user, in a first network platform, where the first user identifier is used for identifying the user in the first network platform and the user resource information is used for performing value transfer during data processing; and
sending a second user identifier of the user and the user resource information to a second network platform, where the second user identifier is used for identifying the user in the second network platform and the first user identifier and the second user identifier are both user identifiers registered by the user separately in the first network platform and the second network platform, so that the second network platform associates the second user identifier with the user resource information.

According to another aspect, a method for associating user resource information is provided, where the method includes:
receiving, by a first network platform, a first user identifier of a user, acquiring user resource information associated with the first user identifier, and sending the user resource information to a second terminal, where the first user identifier is used for identifying the user in the first network platform and the user resource information is used for performing value transfer during data processing;
sending, by the second terminal, a second user identifier of the user and the user resource information to a second network platform, where the second user identifier is used for identifying the user in the second network platform and the first user identifier and the second user identifier are both user identifiers registered by the user separately in the first network platform and the second network platform; and
associating, by the second network platform, the second user identifier with the user resource information.

According to still another aspect, a terminal is provided, where the terminal includes:
an acquisition module, configured to acquire user resource information, associated with a first user identifier of a user, in a first network platform, where the first user identifier is used for identifying the user in the first network platform and the user resource information is used for performing value transfer during data processing; and
a sending module, configured to send a second user identifier of the user and the user resource information to a second network platform, where the second user identifier is used for identifying the user in the second network platform and the first user identifier and the second user identifier are both user identifiers registered by the user separately in the first network platform and the second network platform, so that the second network platform associates the second user identifier with the user resource information.

According to yet another aspect, a system for associating user resource information is provided, where the system includes a first network platform, a second terminal and a second network platform;
the first network platform is configured to receive a first user identifier of a user, acquire user resource information associated with the first user identifier, and send the user resource information to the second terminal, where the first user identifier is used for identifying the user in the first network platform and the user resource information is used for performing value transfer during data processing;
the second terminal is configured to send a second user identifier of the user and the user resource information to the second network platform, where the second user identifier is used for identifying the user in the second network platform and the first user identifier and the second user identifier are both user identifiers registered by the user separately in the first network platform and the second network platform; and
the second network platform is configured to associate the second user identifier with the user resource information.

In the embodiments of the present disclosure, if a user has already associated user resource information in a first network platform, when the user further associates the user resource information in a second network platform, the first network platform sends user resource information associated with a first user identifier to a second terminal and the second terminal may directly send the user resource information to the second network platform, without needing the user to further manually input the user resource information to the second terminal, which reduces time for inputting the user resource information, thereby improving the efficiency of associating the user resource information; and in addition, the second terminal directly acquires the user resource information from the first network platform, so that the user will not input wrong user resource information, which avoids the phenomenon of needing to perform re-association due to an association failure and further improves the efficiency of associating the user resource information.

### BRIEF DESCRIPTION OF THE DRAWINGS

To describe the technical solutions in the embodiments of the present disclosure more clearly, the following briefly introduces the accompanying drawings required for describing the embodiments. Apparently, the accompanying drawings in the following description show merely some embodiments of the present disclosure, and a person of ordinary skill in the art may still derive other drawings from these accompanying drawings without creative efforts.

FIG. 1 is a flowchart of a method for associating user resource information according to some embodiments of the present disclosure.

FIG. 2 is a flowchart of a method for associating user resource information according to some embodiments of the present disclosure.

FIG. 3 is a schematic diagram of a user resource information display interface according to some embodiments of the present disclosure.

FIG. 4 is a flowchart of a method for associating user resource information according to some embodiments of the present disclosure.

FIG. 5 is a schematic structural diagram of a terminal according to some embodiments of the present disclosure.

FIG. 6 is a schematic structural diagram of a system for associating user resource information according to some embodiments of the present disclosure.

### DETAILED DESCRIPTION OF THE PREFERRED EMBODIMENT

To make the objectives, technical solutions, and advantages of the present disclosure clearer, the following further describes the embodiments of the present disclosure in detail with reference to the accompanying drawings.

### Embodiment 1

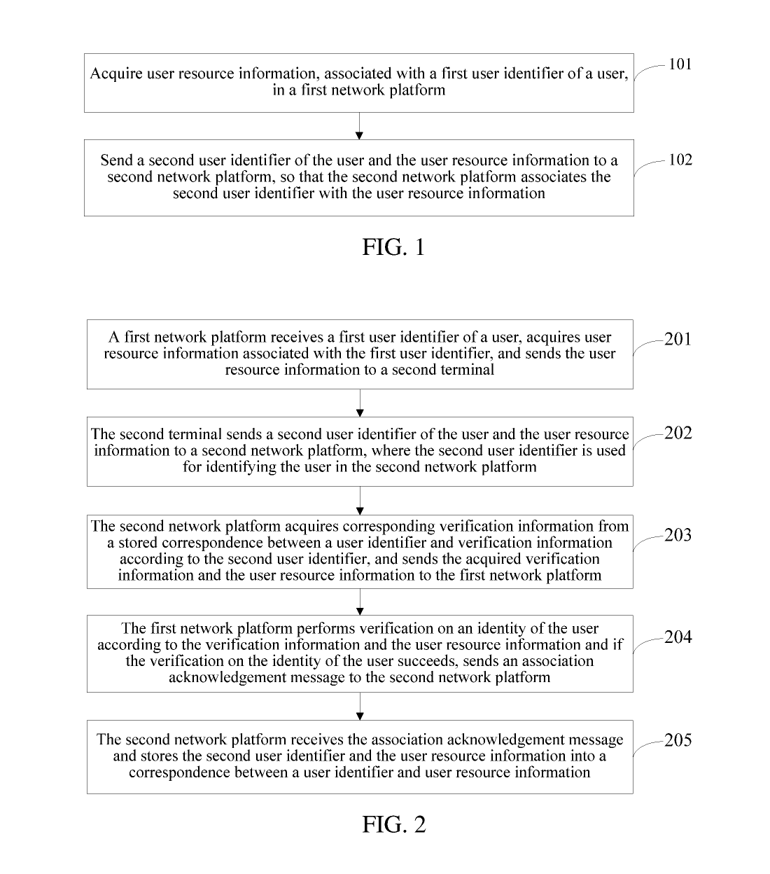

This embodiment of the present disclosure provides a method for associating user resource information. Referring to FIG. 1, the method includes:

Step 101: Acquire user resource information, associated with a first user identifier of a user, in a first network platform, where the first user identifier is used for identifying the user in the first network platform and the user resource information is used for performing value transfer during data processing.

Step 102: Send a second user identifier of the user and the user resource information to a second network platform, where the second user identifier is used for identifying the user in the second network platform and the first user identifier and the second user identifier are both user identifiers registered by the user separately in the first network platform and the second network platform, so that the second network platform associates the second user identifier with the user resource information.

The acquiring user resource information, associated with a first user identifier of a user, in a first network platform includes:
scanning a graphic code displayed by a first terminal, where the graphic code includes the user resource information, associated with the first user identifier of the user, in the first network platform; and
acquiring the user resource information from the scanned graphic code.

Optionally, the acquiring user resource information, associated with a first user identifier of a user, in a first network platform includes:
sending an acquisition request message to the first network platform, where the acquisition request message carries the first user identifier of the user, so that the first network platform acquires, according to the first user identifier, the user resource information associated with the first user identifier; and
receiving the user resource information sent by the first network platform.

This embodiment of the present disclosure may be executed by a terminal.

In the embodiments of the present disclosure, if a user has already associated user resource information in a first network platform, when the user further associates the user resource information in a second network platform, the first network platform sends user resource information associated with a first user identifier to a second terminal and the second terminal may directly send the user resource information to the second network platform, without needing the user to further manually input the user resource information to the second terminal, which reduces time for inputting the user resource information, thereby improving the efficiency of associating the user resource information; and in addition, the second terminal directly acquires the user resource information from the first network platform, so that the user will not input wrong user resource information, which avoids the phenomenon of needing to perform re-association due to an association failure and further improves the efficiency of associating the user resource information.

### Embodiment 2

This embodiment of the present disclosure provides a method for associating user resource information. Referring to FIG. 2, the method includes:

Step 201: A first network platform receives a first user identifier of a user, acquires user resource information associated with the first user identifier, and sends the user resource information to a second terminal, where the first user identifier is used for identifying the user in the first network platform and the user resource information is used for performing value transfer during data processing.

Specifically, this step may be implemented by using the following steps (1) to (2), which include:

(1) The first network platform receives the first user identifier of the user, acquires the user resource information associated with the first user identifier from a stored correspondence between a user identifier and user resource information according to the first user identifier to generate a graphic code, where the graphic code includes the user resource information, and sends the graphic code to a first terminal, so that the first terminal displays the graphic code.

Specifically, the first network platform receives the first user identifier of the user sent by the first terminal, acquires corresponding user resource information from the stored correspondence between a user identifier and user resource information according to the first user identifier, and determines the acquired user resource information as the user resource information associated with the first user identifier. The first network platform generates the graphic code containing the user resource information according to the user resource information associated with the first user identifier by using a graphic code generation algorithm, and sends the graphic code to the first terminal, so that the first terminal displays the graphic code.

When the user intends to import the associated user resource information in the first network platform into a second network platform, the user may click an import button in the first terminal to submit an import command to the first terminal. The first terminal sends the first user identifier of the user to the first network platform.

When the user logs in to the first network platform for the first time, the user needs to register a user account and a login password in the first network platform. After the user successfully logs in to the first network platform according to the registered user account and login password, if the user uses the first network platform to perform the data processing, the user needs to associate the user resource information in the first network platform, that is, store the first user identifier and the user resource information into the correspondence between a user identifier and user resource information.

The first user identifier of the user may be the user account registered in the first network platform and may also be information such as a nickname or an email of the user.

The graphic code generated by the first network platform according to the user resource information associated with the first user identifier by using the graphic code generation algorithm may be a two-dimensional code, a two-dimensional bar code, or the like.

The value transfer processing is processing performed on user resource information of two users according to data needing to be processed, that is, the data needing to be processed may be subtracted from user resource information of a first user and the subtracted data is added to user resource information of a second user.

Furthermore, when the first network platform includes multiple pieces of user resource information associated with the first user identifier, the first network platform may generate a graphic code including the multiple pieces of user resource information according to the multiple pieces of user resource information by using the graphic code generation algorithm. The first network platform sends the graphic code to the first terminal, so that the first terminal displays the graphic code. After the second terminal scans the graphic code, the second terminal displays the multiple pieces of user resource information and the user may select one piece of user resource information from the multiple pieces of user resource information. Certainly, when submitting the import command to the first terminal, the user may further select one piece of account information from the multiple pieces of user resource information associated with the first user identifier. The first terminal sends the first user identifier and a user resource information identifier of the selected user resource information to the first network platform, where the user resource information identifier of the user resource information may be a card number of a card and the card may be a bank card, a supermarket membership card, a virtual card, or the like.

(2) The second terminal scans the graphic code displayed by the first terminal and acquires the user resource information from the graphic code.

Optionally, the step in which the first network platform receives the first user identifier of the user, acquires the user resource information associated with the first user identifier from a stored correspondence between a user identifier and user resource information according to the first user identifier to generate a graphic code, where the graphic code includes the user resource information, and sends the graphic code to a first terminal may also be that: the second terminal directly sends the first user identifier of the user to the first network platform, and the first network platform receives the first user identifier of the user sent by the second terminal, acquires corresponding user resource information from a stored correspondence between a user identifier and user resource information according to the first user identifier, determines the acquired user resource information as the user resource information associated with the first user identifier, and sends the user resource information associated with the first user identifier to the second terminal.

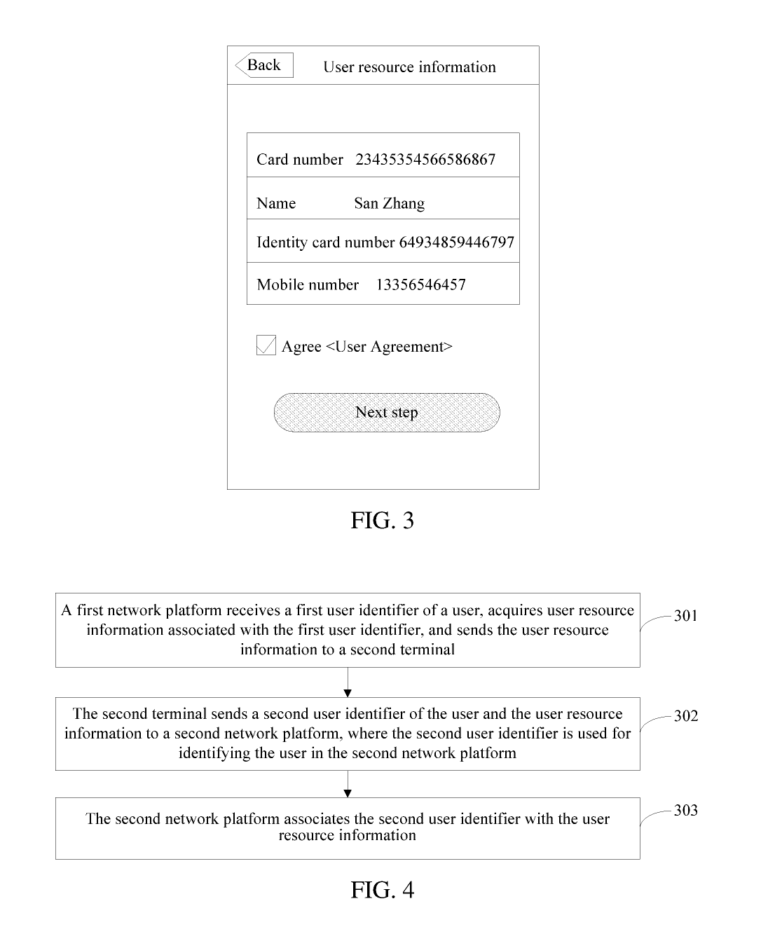

Furthermore, after the second terminal acquires the user resource information associated with the first user identifier, the second terminal fills the user resource information into a display box corresponding to the user resource information and displays the display box to the user. For example, in a user resource information display interface shown in FIG. 3, the user resource information display interface includes multiple display boxes, that is, the user resource information display interface includes a display box of a card number, a display box of a name, a display box of an identity card number and a display box of a mobile number. The second terminal separately fills a card number “23435354566586867” in the user resource information into the display box corresponding to the card number, a name “San Zhang” into the display box corresponding to the name, an identity card number “64934859446797” into the display box corresponding to the identity card number and a mobile number “13356546457” into the display box corresponding to the mobile number and displays the display interface display to the user.

Step 202: The second terminal sends a second user identifier of the user and the user resource information to a second network platform, where the second user identifier is used for identifying the user in the second network platform and the first user identifier and the second user identifier are both user identifiers registered by the user separately in the first network platform and the second network platform.

Specifically, the second terminal acquires the second user identifier of the user and sends the second user identifier and the acquired user resource information to the second network platform.

The second user identifier may be information such as a user account or a nickname, which is registered by the user in the second network platform.

After the user determines that the user resource information displayed by the second terminal is correct, the user may submit a sending command to the second terminal. The second terminal receives the sending command submitted by the user and sends the second user identifier of the user and the user resource information to the second network platform. For example, the user may click a “next step” button in FIG. 3 to submit the sending command to the second terminal.

Step 203: The second network platform acquires corresponding verification information from a stored correspondence between a user identifier and verification information according to the second user identifier, and sends the acquired verification information and the user resource information to the first network platform.

The verification information may be real-name authentication information of the user and may also be a third user identifier associated with the second user identifier. The third user identifier may be an instant messaging account of the user.

For example, the second user identifier is a Name2. The second network platform acquires corresponding verification information from a correspondence, between a user identifier and verification information, shown in Table 1 below according to the second user identifier Name2, where the corresponding verification information is verification information 2, and sends the acquired verification information 2 and the user resource information to the first network platform.

TABLE 1

| User identifier | Verification information |
|---|---|
| Name1 | Verification information 1 |
| Name2 | Verification information 2 |
| Name3 | Verification information 3 |

Step 204: The first network platform performs verification on an identity of the user according to the verification information and the user resource information and if the verification on the identity of the user succeeds, sends an association acknowledgement message to the second network platform.

Specifically, the first network platform acquires the first user identifier associated with the user resource information, acquires corresponding verification information from the stored correspondence between a user identifier and verification information according to the first user identifier; and if the acquired verification information is the same as the verification information sent by the second network platform, determines that the verification on the identity of the user succeeds and sends the association acknowledgement message to the second network platform.

The specific operation in which the first network platform acquires the first user identifier associated with the user resource information may be that: the first network platform acquires a corresponding user identifier from the stored correspondence between a user identifier and user resource information according to the user resource information, and determines the acquired user identifier as the first user identifier associated with the user resource information.

Furthermore, if the acquired verification information is different from the verification information sent by the second network platform, the first network platform determines that the verification on the identity of the user fails and sends verification failure prompt information to the second network platform to prompt the user to re-associate the user resource information.

Optionally, the second network platform may further send the second user identifier to the first network platform. After the verification on the identity of the user performed by the first network platform succeeds, the first network platform may further generate a verification code, create a correspondence between the second user identifier and the verification code, and send the verification code to the second terminal. The second terminal receives the verification code input by the user and sends the second user identifier and the verification code to the second network platform, so that the second network platform forwards the second user identifier and the verification code to the first network platform. The first network platform receives the second user identifier and the verification code, performs verification on the identity of the user according to the second user identifier and the verification code, and if the verification succeeds, sends the association acknowledgement message to the second network platform.

The specific operation of performing verification on the identity of the user according to the second user identifier and the verification code may be: acquiring a corresponding verification code from the correspondence between a second user identifier and a verification code according to the second user identifier, comparing the acquired verification code with the received verification code, and if the two are the same, determining that the verification on the identity of the user succeeds, or else, determining that the verification on the identity of the user fails.

After the verification on the identity of the user is performed according to the verification information, verification on the identity of the user is further performed by means of the verification code, which improves the security of associating the user resource information of the user.

For example, the first network platform may acquire a mobile number from the user resource information and send a generated verification code to the second terminal by means of a short message service message.

Furthermore, the first network platform stores a correspondence between the second user identifier and the user resource information.

For example, when the verification information is the real-name authentication information of the user and real-name authentication has already been performed on the user in the first network platform, the first network platform acquires the corresponding user identifier from the stored correspondence between a user identifier and user resource information according to the user resource information, and determines the acquired user identifier as the first user identifier associated with the user resource information. The first network platform acquires corresponding real-name authentication information from a stored correspondence between a user identifier and real-name authentication information according to the first user identifier. If the acquired real-name authentication information is the same as real-name authentication information sent by the second network platform, the first network platform determines that the verification on the identity of the user succeeds, or else, the first network platform determines that the verification on the identity of the user fails.

Furthermore, if real-name authentication is not performed on the user in the first network platform, the first network platform may acquire corresponding real-name information from a stored correspondence between a user resource information identifier and real-name information according to a user resource information identifier included in the user resource information sent by the second network platform, compare the acquired real-name information and the real-name authentication information sent by the second network platform, and if the two are the same, determine that the verification on the identity of the user succeeds, or else, determine that the verification on the identity of the user fails.

For another example, when the verification information is the third user identifier associated with the second user identifier, the first network platform acquires the corresponding user identifier from the stored correspondence between a user identifier and user resource information according to the user resource information, and determines the acquired user identifier as the first user identifier associated with the user resource information. The first network platform acquires a third user identifier associated with the first user identifier from a stored correspondence between a first user identifier and a third user identifier according to the first user identifier. If the third user identifier associated with the second user identifier is the same as the third user identifier associated with the first user identifier, the first network platform determines that the verification on the identity of the user succeeds, or else, the first network platform determines that the verification on the identity of the user fails.

Step 205: The second network platform receives the association acknowledgement message and stores the second user identifier and the user resource information into a correspondence between a user identifier and user resource information.

For example, the second network platform receives the association acknowledgement message and stores the second user identifier Name2 and the user resource information into a correspondence, between a user identifier and user resource information, shown in Table 2 below.

TABLE 2

| User | User resource information | | | |
|---|---|---|---|---|
| identifier | Card number | Name | Identity card number | Mobile number |
| Name2 | 23435354566586867 | San Zhang | 64934859446797 | 13356546457 |

In the embodiments of the present disclosure, if a user has already associated user resource information in a first network platform, when the user further associates the user resource information in a second network platform, the first network platform sends user resource information associated with a first user identifier to a second terminal and the second terminal may directly send the user resource information to the second network platform, without needing the user to further manually input the user resource information to the second terminal, which reduces time for inputting the user resource information, thereby improving the efficiency of associating the user resource information; and in addition, the second terminal directly acquires the user resource information from the first network platform, so that the user will not input wrong user resource information, which avoids the phenomenon of needing to perform re-association due to an association failure and further improves the efficiency of associating the user resource information.

### Embodiment 3

This embodiment of the present disclosure provides a method for associating user resource information. Referring to FIG. 4, the method includes:

Step 301: A first network platform receives a first user identifier of a user, acquires user resource information associated with the first user identifier, and sends the user resource information to a second terminal, where the first user identifier is used for identifying the user in the first network platform and the user resource information is used for performing value transfer during data processing.

Step 302: The second terminal sends a second user identifier of the user and the user resource information to a second network platform, where the second user identifier is used for identifying the user in the second network platform and the first user identifier and the second user identifier are both user identifiers registered by the user separately in the first network platform and the second network platform.

Step 303: The second network platform associates the second user identifier with the user resource information.

That a first network platform receives a first user identifier of a user, acquires user resource information associated with the first user identifier, and sends the user resource information to a second terminal includes that:

the first network platform receives the first user identifier of the user, acquires the user resource information associated with the first user identifier from a stored correspondence between a user identifier and user resource information according to the first user identifier to generate a graphic code, where the graphic code includes the user resource information, and sends the graphic code to a first terminal, so that the first terminal displays the graphic code; and

the second terminal scans the graphic code displayed by the first terminal and acquires the user resource information from the graphic code.

That the second network platform associates the second user identifier with the user resource information includes that:

the second network platform acquires corresponding verification information from a stored correspondence between a user identifier and verification information according to the second user identifier, and sends the acquired verification information and the user resource information to the first network platform;

the first network platform performs verification on an identity of the user according to the verification information and the user resource information and if the verification on the identity of the user succeeds, sends an association acknowledgement message to the second network platform; and

the second network platform receives the association acknowledgement message and stores the second user identifier and the user resource information into a correspondence between a user identifier and user resource information.

That the first network platform performs verification on an identity of the user according to the verification information and the user resource information includes that:

the first network platform acquires a first user identifier associated with the user resource information and acquires corresponding verification information from a stored correspondence between a user identifier and verification information according to the first user identifier; and

if the acquired verification information is the same as the verification information sent by the second network platform, determines that the verification on the identity of the user succeeds, or else, determines that the verification on the identity of the user fails.

In the embodiments of the present disclosure, if a user has already associated user resource information in a first network platform, when the user further associates the user resource information in a second network platform, the first network platform sends user resource information associated with a first user identifier to a second terminal and the second terminal may directly send the user resource information to the second network platform, without needing the user to further manually input the user resource information to the second terminal, which reduces time for inputting the user resource information, thereby improving the efficiency of associating the user resource information; and in addition, the second terminal directly acquires the user resource information from the first network platform, so that the user will not input wrong user resource information, which avoids the phenomenon of needing to perform re-association due to an association failure and further improves the efficiency of associating the user resource information.

### Embodiment 4

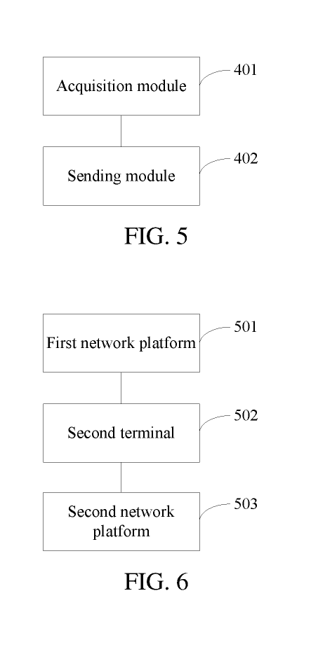

This embodiment of the present disclosure provides a terminal. Referring to FIG. 5, the terminal includes:

an acquisition module 401, configured to acquire user resource information, associated with a first user identifier of a user, in a first network platform, where the first user identifier is used for identifying the user in the first network platform and the user resource information is used for performing value transfer during data processing; and

a sending module 402, configured to send a second user identifier of the user and the user resource information to a second network platform, where the second user identifier is used for identifying the user in the second network platform and the first user identifier and the second user identifier are both user identifiers registered by the user separately in the first network platform and the second network platform, so that the second network platform associates the second user identifier with the user resource information.

The acquisition module 401 includes:

a scanning unit, configured to scan a graphic code displayed by a first terminal, where the graphic code includes the user resource information, associated with the first user identifier of the user, in the first network platform; and

an acquisition unit, configured to acquire the user resource information from the scanned graphic code.

Optionally, the acquisition module 401 includes:

a sending unit, configured to send an acquisition request message to the first network platform, where the acquisition request message carries the first user identifier of the user, so that the first network platform acquires, according to the first user identifier, the user resource information associated with the first user identifier; and

a receiving unit, configured to receive the user resource information sent by the first network platform.

In the embodiments of the present disclosure, if a user has already associated user resource information in a first network platform, when the user further associates the user resource information in a second network platform, the first network platform sends user resource information associated with a first user identifier to a second terminal and the second terminal may directly send the user resource information to the second network platform, without needing the user to further manually input the user resource information to the second terminal, which reduces time for inputting the user resource information, thereby improving the efficiency of associating the user resource information; and in addition, the second terminal directly acquires the user resource information from the first network platform, so that the user will not input wrong user resource information, which avoids the phenomenon of needing to perform re-association due to an association failure and further improves the efficiency of associating the user resource information.

### Embodiment 5

This embodiment of the present disclosure provides a system for associating user resource information. Referring to FIG. 6, the system includes: a first network platform 501, a second terminal 502 and a second network platform 503.

The first network platform 501 is configured to receive a first user identifier of a user, acquire user resource information associated with the first user identifier, and send the user resource information to a second terminal, where the first user identifier is used for identifying the user in the first network platform and the user resource information is used for performing value transfer during data processing.

The second terminal 502 is configured to send a second user identifier of the user and the user resource information to a second network platform, where the second user identifier is used for identifying the user in the second network platform and the first user identifier and the second user identifier are both user identifiers registered by the user separately in the first network platform and the second network platform.

The second network platform 503 is configured to associate the second user identifier with the user resource information.

The first network platform 501 is configured to receive the first user identifier of the user, acquire the user resource information associated with the first user identifier from a stored correspondence between a user identifier and user resource information according to the first user identifier to generate a graphic code, where the graphic code includes the user resource information, and send the graphic code to a first terminal, so that the first terminal displays the graphic code.

The second terminal 502 is configured to scan the graphic code displayed by the first terminal and acquire the user resource information from the scanned graphic code.

The second network platform 503 is configured to acquire corresponding verification information from a stored correspondence between a user identifier and verification information according to the second user identifier, and send the acquired verification information and the user resource information to the first network platform.

The first network platform 501 is configured to perform verification on an identity of the user according to the verification information and the user resource information and if the verification on the identity of the user succeeds, send an association acknowledgement message to the second network platform.

The second network platform 503 is further configured to receive the association acknowledgement message and store the second user identifier and the user resource information into the correspondence between a user identifier and user resource information.

The first network platform 501 is configured to acquire a first user identifier associated with the user resource information and acquire corresponding verification information from the stored correspondence between a user identifier and verification information according to the first user identifier.

The first network platform 501 is further configured to: if the acquired verification information is the same as the verification information sent by the second network platform, determine that the verification on the identity of the user succeeds, or else, determine that the verification on the identity of the user fails.

In the embodiments of the present disclosure, if a user has already associated user resource information in a first network platform, when the user further associates the user resource information in a second network platform, the first network platform sends user resource information associated with a first user identifier to a second terminal and the second terminal may directly send the user resource information to the second network platform, without needing the user to further manually input the user resource information to the second terminal, which reduces time for inputting the user resource information, thereby improving the efficiency of associating the user resource information; and in addition, the second terminal directly acquires the user resource information from the first network platform, so that the user will not input wrong user resource information, which avoids the phenomenon of needing to perform re-association due to an association failure and further improves the efficiency of associating the user resource information.

It should be noted that when the terminal for associating user resource information provided by the foregoing embodiment associates user resource information, the division of the foregoing functional modules is merely used as an example for illustration. In practical applications, different functional modules may be allocated to complete the foregoing functions as required, that is, an internal structure of the terminal is divided into different functional modules, so as to complete all or some of the functions described above. In addition, the terminal for associating user resource information provided by the foregoing embodiment and the method embodiments of associating user resource information belong to a same idea, and reference is made to the method embodiments for details of a specific implementation process thereof, which are not described herein again.

The sequence numbers of the foregoing embodiments of the present disclosure are merely for the convenience of description, and do not imply the preference among the embodiments.

A person of ordinary skill in the art may understand that all or some of the steps of the foregoing embodiments may be implemented by using hardware, or may be implemented by a program instructing relevant hardware. The program may be stored in a computer readable storage medium. The storage medium may be a read-only memory, a magnetic disk, an optical disc, or the like.

The foregoing descriptions are merely exemplary embodiments of the present disclosure, but are not intended to limit the present disclosure. Any modification, equivalent replacement, and improvement derived within the spirit and principle of the present disclosure shall fall within the protection scope of the present disclosure.

What is claimed is:

1. A method for associating user resource information, wherein the method comprises:
acquiring user resource information, associated with a first user identifier of a user, in a first network platform, wherein the first user identifier is used for identifying the user in the first network platform and the user resource information is used for performing value transfer during data processing; and
sending a second user identifier of the user and the user resource information to a second network platform, wherein the second user identifier is used for identifying the user in the second network platform and the first user identifier and the second user identifier are both user identifiers registered by the user separately in the first network platform and the second network platform, so that the second network platform associates the second user identifier with the user resource information.

2. The method according to claim 1, wherein the acquiring user resource information, associated with a first user identifier of a user, in a first network platform comprises:
scanning a graphic code displayed by a first terminal, wherein the graphic code comprises the user resource information, associated with the first user identifier of the user, in the first network platform; and
acquiring the user resource information from the scanned graphic code.

3. The method according to claim 1, wherein the acquiring user resource information, associated with a first user identifier of a user, in a first network platform comprises:
sending an acquisition request message to the first network platform, wherein the acquisition request message carries the first user identifier of the user, so that the first network platform acquires, according to the first user identifier, the user resource information associated with the first user identifier; and
receiving the user resource information sent by the first network platform.

4. A method for associating user resource information, wherein the method comprises:
receiving, by a first network platform, a first user identifier of a user, acquiring user resource information associated with the first user identifier, and sending the user resource information to a second terminal, wherein the first user identifier is used for identifying the user in the first network platform and the user resource information is used for performing value transfer during data processing;
sending, by the second terminal, a second user identifier of the user and the user resource information to a second network platform, wherein the second user identifier is used for identifying the user in the second network platform and the first user identifier and the second user identifier are both user identifiers registered by the user separately in the first network platform and the second network platform; and
associating, by the second network platform, the second user identifier with the user resource information.

5. The method according to claim 4, wherein the receiving, by a first network platform, a first user identifier of a user, acquiring user resource information associated with the first user identifier, and sending the user resource information to a second terminal comprises:
receiving, by the first network platform, the first user identifier of the user, acquiring the user resource information associated with the first user identifier from a stored correspondence between a user identifier and user resource information according to the first user identifier to generate a graphic code, wherein the graphic code comprises the user resource information, and sending the graphic code to a first terminal, so that the first terminal displays the graphic code; and
scanning, by the second terminal, the graphic code displayed by the first terminal and acquiring the user resource information from the graphic code.

6. The method according to claim 4, wherein the associating, by the second network platform, the second user identifier with the user resource information comprises:
acquiring, by the second network platform, corresponding verification information from a stored correspondence between a user identifier and verification information according to the second user identifier, and sending the acquired verification information and the user resource information to the first network platform;
performing, by the first network platform, verification on an identity of the user according to the verification information and the user resource information and if the verification on the identity of the user succeeds, sending an association acknowledgement message to the second network platform; and
receiving, by the second network platform, the association acknowledgement message and storing the second user identifier and the user resource information into a correspondence between a user identifier and user resource information.

7. The method according to claim 6, wherein the performing, by the first network platform, verification on an identity of the user according to the verification information and the user resource information comprises:
acquiring, by the first network platform, the first user identifier associated with the user resource information and acquiring corresponding verification information from the stored correspondence between a user identifier and verification information according to the first user identifier; and
if the acquired verification information is the same as the verification information sent by the second network platform, determining that the verification on the identity of the user succeeds, or else, determining that the verification on the identity of the user fails.

8. A terminal, wherein the terminal comprises:
an acquisition module, configured to acquire user resource information, associated with a first user identifier of a user, in a first network platform, wherein the first user identifier is used for identifying the user in the first network platform and the user resource information is used for performing value transfer during data processing; and
a sending module, configured to send a second user identifier of the user and the user resource information to a second network platform, wherein the second user identifier is used for identifying the user in the second network platform and the first user identifier and the second user identifier are both user identifiers registered by the user separately in the first network platform and the second network platform, so that the second network platform associates the second user identifier with the user resource information.

9. The terminal according to claim 8, wherein the acquisition module comprises:
a scanning unit, configured to scan a graphic code displayed by a first terminal, wherein the graphic code comprises the user resource information, associated with the first user identifier of the user, in the first network platform; and
an acquisition unit, configured to acquire the user resource information from the scanned graphic code.

10. The terminal according to claim 8, wherein the acquisition module comprises:
a sending unit, configured to send an acquisition request message to the first network platform, wherein the acquisition request message carries the first user identifier of the user, so that the first network platform acquires, according to the first user identifier, the user resource information associated with the first user identifier; and
a receiving unit, configured to receive the user resource information sent by the first network platform.

11. A system for associating user resource information, wherein the system comprises: a first network platform, a second terminal and a second network platform;
the first network platform is configured to receive a first user identifier of a user, acquire user resource information associated with the first user identifier, and send the user resource information to the second terminal, wherein the first user identifier is used for identifying the user in the first network platform and the user resource information is used for performing value transfer during data processing;
the second terminal is configured to send a second user identifier of the user and the user resource information to the second network platform, wherein the second user identifier is used for identifying the user in the second network platform and the first user identifier and the second user identifier are both user identifiers registered by the user separately in the first network platform and the second network platform; and
the second network platform is configured to associate the second user identifier with the user resource information.

12. The system according to claim 11, wherein
the first network platform is configured to receive the first user identifier of the user, acquire the user resource information associated with the first user identifier from a stored correspondence between a user identifier and user resource information according to the first user identifier to generate a graphic code, wherein the graphic code comprises the user resource information, and send the graphic code to a first terminal, so that the first terminal displays the graphic code; and
the second terminal is configured to scan the graphic code displayed by the first terminal and acquire the user resource information from the graphic code.

13. The system according to claim 11, wherein
the second network platform is configured to acquire corresponding verification information from a stored correspondence between a user identifier and verification information according to the second user identifier, and send the acquired verification information and the user resource information to the first network platform;
the first network platform is configured to perform verification on an identity of the user according to the verification information and the user resource information and if the verification on the identity of the user succeeds, send an association acknowledgement message to the second network platform; and
the second network platform is further configured to receive the association acknowledgement message and store the second user identifier and the user resource information into a correspondence between a user identifier and user resource information.

14. The system according to claim 13, wherein
the first network platform is configured to acquire the first user identifier associated with the user resource information and acquire corresponding verification information from the stored correspondence between a user identifier and verification information according to the first user identifier; and
the first network platform is further configured to: if the acquired verification information is the same as the verification information sent by the second network platform, determine that the verification on the identity of the user succeeds, or else, determine that the verification on the identity of the user fails.
